(19) United States
(12) Patent Application Publication
(10) Pub. No.: US 2007/0299226 A1
(43) Pub. Date: Dec. 27, 2007

(54) Method for Preparing Adhesive Acrylic Ester Polymer Syrup

(76) Inventors: Jong-suh Park, Chooncheongnam-do (KR); Sun-hyuk Choi, Daejeon (KR); Jung-uk Choi, Daejeon (KR)

Correspondence Address: MCKENNA LONG & ALDRIDGE LLP, 1900 K STREET, NW, WASHINGTON, DC, 20006, US

(21) Appl. No.: 11/666,280

(22) PCT Filed: Jun. 1, 2006
(86) PCT No.: PCT/KR06/02104

§ 371 Date: Apr. 25, 2007

(30) Foreign Application Priority Data
Jun. 1, 2005 (KR) 10-2005-0046746

(51) Int. Cl. C08F 2/02; C08F 120/18; C08F 20/10; C08F 4/04; C08F 4/28

(52) U.S. Cl. 526/218.1; 526/224; 526/227; 526/328; 526/329.7

(57) ABSTRACT

The present invention relates to a method for preparing an acrylic ester polymer syrup by bulk polymerization, and more particularly, to a method for preparing an acrylic ester polymer syrup, which comprises the steps of: supplying a monomer solution and an initiator solution to a monomer solution reservoir and an initiator solution reservoir, respectively; supplying the monomer solution and the initiator solution to a complete-mixing type continuous reactor, while maintaining the dissolved oxygen in the monomer solution reservoir and the initiator solution reservoir at 0.0001 to 3 ppm, separately or after mixing prior to the supply; and performing bulk polymerization continuously while maintaining the solution mixture supplied to the continuous reactor at 70 to 150 ° C. and 1 to 10 atm, with a mean residence time of 30 to 240 minutes. In accordance with the present invention, an acrylic ester polymer syrup can be obtained with a degree of polymerization of 20 to 70% at a low polymerization temperature, even with a small amount of initiator. Productivity can be improved by reducing reaction time with the use of an initiator having a short half-life and polymerization can be performed very stably and continuously without gelation.

### TECHNICAL FIELD

The present invention relates to a method for preparing an acrylic ester polymer syrup by bulk polymerization, and more particularly, to a method for preparing an acrylic ester polymer syrup by bulk polymerization capable of polymerizing an acrylic ester polymer syrup with a degree of polymerization of 20 to 70% at a low polymerization temperature, even with a small amount of initiator, capable of improving productivity by reducing reaction time with the use of an initiator having a short half-life, and capable of performing polymerization stably and continuously without gelation.

### BACKGROUND ART

Generally, an acrylic ester polymer syrup is an amorphous, transparent thermoplastic polymer. With superior transparency and easily adjustable adhesiveness, it is used for various purposes, including adhesive sheets, protective coating films, adhesives, etc.

Formerly, acrylic ester polymer syrups were prepared by various methods, including solution polymerization, emulsion polymerization and suspension polymerization. But, these methods consume a lot of energy in removal of residues, it is difficult to produce polymer syrups with good capacity, and removal of a solvent is required following polymerization. For these reasons, it is the current trend to prepare acrylic ester polymer syrups by bulk polymerization or photopolymerization.

Bulk polymerization may be classified into the continuous method and the discontinuous method. Until now, batch polymerization, which is a discontinuous method, has usually been utilized. However, the batch polymerization is quite unfavorable in terms of productivity and energy savings and a variety of techniques to control gelation which causes abrupt heating and excessive reaction, are required.

When bulk polymerization is batchwisely performed in a common batch reactor, heat transfer is incomplete because of the absence of a solvent which might cause an abrupt increase in viscosity. And, the degree of polymerization increases without reaching radical termination, thereby resulting in partial gelation and creating a non-uniform resin.

As a solution to overcome these problems, the methods in which batch reactors are used but polymerization is performed under mild reaction conditions have been proposed. In these methods, polymerization is terminated by force when the degree of polymerization or the viscosity reaches a predetermined level, while maintaining a constant reaction temperature.

For example, Japanese Patent Laid-Open No. 1997-067495 discloses quenching method by monomer addition. But, these polymerization methods could not solve the problems of an abrupt increase in viscosity during the later stage of a reaction and the difference in physical properties. Additionally, the resultant polymer syrup has poor storage stability because of the presence of a polymerization initiator after the polymerization has been completed.

Therefore, research has been undertaken to find a polymerization method in which a batch reactor is used, a runaway reaction can be avoided, and control of molecular weight is facile.

As a practical example of bulk polymerization in which no initiator is used to avoid a runaway reaction, Japanese Patent Laid-Open No. 2001-302705 discloses a bulk polymerization process using a compound having both thiol and carboxyl groups and which uses no initiator. However, polymerization with an initiator is problematic in that, because the reaction is triggered by the propagation of thermally-produced radicals, the reaction proceeds very slowly. Consequently, the reaction should be performed at a relatively high temperature and the polymerization yield is not good.

As an example of bulk polymerization in which a runaway reaction can be avoided while using an initiator, Japanese Patent Laid-Open No. 2000-313704 discloses a method of preparing an acryl polymer syrup using a polymerization initiator having a ten hour half-life temperature of up to 41° C. within 0.0001 to 0.5 part by weight at a reaction temperature of 20 to 80° C. Through self-heating of the reactants, a peak exothermic temperature of 100 to 140° C. is attained and a degree of polymerization as high as 10 to 50% is attained. In this type of polymerization, the reaction proceeds by self-heating and the degree of polymerization increases abruptly at the early stage of the reaction because of an abruptly increased radical concentration, which leads to the peak exothermic temperature. At the elevated temperature, most of the initiator is consumed, and thus a runaway reaction can be avoided. However, initiators having such a low half-life temperature require great care during handling and storing. Also, because the reaction proceeds discontinuously, it is disadvantageous in terms of productivity and economics.

### DISCLOSURE OF INVENTION

### Technical Problem

An object of the present invention is to provide a method for preparing an acrylic ester polymer syrup by bulk polymerization. The method is capable of polymerizing an acrylic ester polymer syrup with a degree of polymerization of 20 to 70% at a low polymerization temperature, even with a small amount of initiator, is capable of improving productivity by reducing reaction time with the use of an initiator having a short half-life, and is capable of performing polymerization stably and continuously without gelation.

### TECHNICAL SOLUTION

To attain the above object, the present invention provides a method for preparing an acrylic ester polymer syrup using a polymerization apparatus comprising a complete-mixing type continuous reactor, a monomer solution reservoir, and an initiator solution reservoir, which comprises the steps of:

a) supplying a monomer solution and an initiator solution to the monomer solution reservoir and the initiator solution reservoir, respectively;

b) supplying the monomer solution and the initiator solution to the complete-mixing type continuous reactor, while maintaining the dissolved oxygen in the monomer solution reservoir and the initiator solution reservoir at 0.0001 to 3 ppm, separately or after mixing prior to the supply; and

c) performing bulk polymerization continuously while maintaining the solution mixture supplied to the continuous reactor at 70to 150° C. and 1 to 10 atm, with a mean residence time of 30 to 240 minutes.

Hereunder is given a detailed description of the present invention.

The preparation of acrylic ester polymer syrup in accordance with the present invention is performed with a common polymerization apparatus comprising a complete-mixing type continuous reactor a monomer solution reservoir, and an initiator solution reservoir.

a) Supply of Solutions to Reservoirs

In this step, a monomer solution and an initiator solution are supplied, respectively, to the monomer solution reservoir and the initiator solution reservoir. The monomer solution comprises i) an acrylic ester monomer and ii) a molecular weight controller and the initiator solution comprises i) an acrylic ester monomer, ii) a molecular weight controller and iii) an initiator having a ten hour half-life temperature of 40 to 135° C.

For the acrylic ester monomer used in the present invention may be an acrylic ester monomer having a C₁-C₁₂ alkyl group. A polar acrylic monomer copolymerizable with the acrylic ester monomer may be used along with the acrylic ester monomer.

Examples of such an acrylic ester monomer are methyl(meth)acrylate, ethyl(meth)acrylate, propyl(meth)acrylate, butyl(meth)acrylate, hexyl(meth)acrylate, isooctyl(meth)acrylate, 2-ethylhexyl(meth)acrylate, isononyl(meth)acrylate, etc.

Examples of the polar acrylic monomer copolymerizable with the acrylic ester monomer are a carboxyl-containing monomer such as (meth)acrylic acid, maleic acid and fumaric acid; a hydroxyl-containing monomer such as hydroxy(meth)acrylate and hydroxy(meth)methylacrylate; a nitrogen-containing monomer such as acrylimide. N-vinylpyrrolidone and N-vinylcaprolactam; etc. The content of the polar acrylic monomer is not particularly limited, but preferably it is used in 1 to 20 parts by weight per 100 parts by weight of the acrylic ester monomer.

For the molecular weight controller used in the present invention is a mercaptan-based chain transfer agent having a thiol (—SH) group and is not particularly limited. Specifically, an alkyl mercaptan such as ethylmercaptan, butylmercaptan, hexylmercaptan and dodecylmercaptan; a thiolphenol such as phenylmercaptan and benzylmercaptan; a hydroxyl-containing mercaptan such as thioglycolic acid and 3-mercaptopropionic acid; a mercaptan having two or more functional groups such as pentaerythritol tetrakis(3-mercapto)propionate; etc. may be used alone or in combination.

The molecular weight controller is used in 0.0001 to 5 wt % per 100 wt % of the total monomers used to obtain an adhesive having a weight-average molecular weight of 100,000 to 700,000. If its content is less than 0.0001 wt %, polymerization may proceed too quickly. In contrast, if it is more than 5 wt %, polymerization proceeds slowly and the physical properties suitable for an adhesive are not attained.

For the initiator used in the present invention, one having a short half-life and thereby capable of reducing residence time, or the reaction time, and improving productivity, degree of polymerization, and capable of being used in a small amount is preferable.

Thus, the initiator used in the present invention preferably has a ten hour half-life temperature of 40 to t35° C. under a polymerization temperature condition of 70 to 150° C. A ten hour half-life temperature below 40° C. is unfavorable with regard to storage stability. If an initiator having a ten hour half-life temperature up to 40° C. is used, it should be used in excess to attain an ideal degree of polymerization, which may be the cause of excessive generation of byproducts. In contrast, if the ten hour half-life temperature of the polymerization initiator is more than 135° C., the polymerization time has to be prolonged significantly for a stable polymerization, because the initiator decomposes too slowly, which makes the process less productive and uneconomical.

For the initiator having a ten hour half-life temperature of 40 to 135° C., an azo-based initiator or a peroxide-based initiator can be used.

Specifically, the azo-based initiator may be 2,2′-azobis(isobutyronitrile) (AIBN), 2,2′-azobis(2,4-dimethylvaleronitrile), 2,2′-azobis(2-methylbutyronitrile), az obi-sisobutanol diacetate, 1,1 -azobiscyclohexanecarbonitrile, 2-phenylazo-2,4-dimethyl-4-methoxyvaleronitrile, etc.

The peroxide-based initiator may be a diacyl peroxide-, peroxyester-, peroxydi- carbonate-, hydroperoxide-, peroxyketal-, ketone peroxide- or dialkyl peroxide-based initiator. For example, it may be 3,5,5-trimethylhexanoyl peroxide, lauroyl peroxide, dibenzoyl peroxide (BPO), 1,1-dimethyl-3-hydroxybutyl peroxyneodecanoate, t-butyl peroxyneodecanoate, t-amyl peroxypivalate, t-butyl peroxypivalate, 2,5-dimethyl-2,5-di-(2-ethylhexanoyl peroxy)hexane, t-amyl peroxy-2-ethylhexanoate, t-butyl peroxy-2-peroxy-2-etylhexanoate, t-amyl-(2-ethylhexyl)monoperoxycarbonate, t-butyl-isopropyl monoperoxycarbonate, 2,5-dimethyl-2,5-di(benzoylperoxy)hexane, t-amyl peroxyacetate, t-butyl-(2-ethylhexyl)monoperoxycarbonate, t-amyl peroxybenzoate, t-butyl peroxyacetate, t-butyl peroxy-3,5,5,-trimethylhexanoate, t-butyl peroxybenzoate, diisopropyl peroxydicarbonate, di-sec-butyl peroxydicarbonate, 2,5-dihydroperoxy-2,5-dimethylhexane, cumene hydroperoxide, t-amyl hydroperoxide, t-butyl hydroperoxide, 1,1-di(t-amylperoxy)cyclohexane, 1,1-di(t-butylperoxy)3,3,5-trimethylcyclohexane, 1,1-di(t-butylperoxy)cyclohexane, methyl ethyl ketone peroxide, 2,5-dimethyl-2,5-di(t-butylperoxy)hexane, di-t-amyl peroxide, di-t-butyl peroxide, 2,5-dimethyl-2,5-di(t-butylperoxy)hexane-3, etc.

Preferably, the initiator is comprised at 0.00001to 1 wt %, and more preferably 0.00005 to 0.1 wt %, per 100 wt % of the total monomer monomers. If the content is less than 0.00001 wt %, productivity may be not good. In contrast, if it is more than 1 wt %, a runaway reaction may occur because of gelation.

b) Supply to Continuous Reactor

In this step, the monomer solution and the initiator solution are supplied to the complete-mixing type continuous reactor, while maintaining the dissolved oxygen in the monomer solution reservoir to which the monomer solution is supplied and the initiator solution reservoir to which the initiator solution is supplied at 0.0001 to 3 ppm.

The monomer solution and the initiator solution may be supplied to the continuous reactor separately or after being mixed together prior to the supply.

If the dissolved oxygen in the monomer solution reservoir and the initiator solution reservoir is less than 0.0001 ppm, bubbling with excessive nitrogen or high vacuumization is required. In contrast, if the dissolved oxygen is more than 3 ppm, a runaway reaction may occur.

c) Continuous Bulk Polymerization

In this step, the solution mixture supplied to the continuous reactors in the step b) is continuously bulk polymerized at 70 to 150° C., preferably 80 to 140° C., and 1 to 10 atm, with a mean residence time of 30 to 240 minutes.

If the bulk polymerization temperature is less than 70° C., the resultant adhesive becomes too viscous. As a result, the reaction product may not be discharged properly, gelation may occur partially due to improper heat transfer, or a runaway reaction may occur because of anomalous radical termination. In contrast, if it is more than 150° C. excess initiator has to be used to attain a high degree of polymerization.

If the residence time during the bulk polymerization is less than 30 minutes, the initiator may remain in the polymerization product, thereby worsening polymerization stability after the completion of reaction. In contrast, if it is more than 240 minutes, productivity may be decreased.

### ADVANTAGEOUS EFFECTS

The method for preparing an acrylic ester polymer syrup in accordance with the present invention is advantageous in that polymerization can be performed very stably with a final degree of polymerization of 20 to 70%.

When applied to polymerizing a high-purity acrylic ester polymer syrup for use as adhesives particularly suitable for optical products by continuous bulk polymerization. The present invention offers the followings advantages: 1) the degree of polymerization can be increased while avoiding gelation; 2) polymerization time can be reduced. The present invention is characterized in that: a peroxide-based or azo-based initiator having a ten hour half-life temperature of 40 to 135° C. is used; a polymerization apparatus comprising a complete-mixing type continuous reactor, a monomer solution reservoir and an initiator solution reservoir is used for stable polymerization with no gelation; the monomer solution and the initiator solution are supplied to the complete-mixing type continuous reactor, respectively, from the monomer solution reservoir and the initiator solution reservoir, while maintaining the dissolved oxygen in the reservoirs at 0.0001 to 3 ppm; and polymerization is performed under specific conditions. And productivity can be also improved much more compared with batch polymerization.

### BRIEF DESCRIPTION OF THE DRAWINGS

The above and other objects, features and advantages of the present invention will become apparent from the following description of the preferred embodiments given in conjunction with the accompanying drawing, in which:

FIG. 1 is a schematic diagram of the polymerization apparatus used for performing polymerization in accordance with the present invention.

### EXPLANATION OF MAIN MARK OF THE DRAWING

1: Monomer solution reservoir 2: Initiator solution reservoir
3: Complete-mixing type continuous reactor 4, 5: Metric pump
6: Gear pump 7: Filter system

### BEST MODE FOR CARRYING OUT THE INVENTION

Hereinafter, the embodiments of the present invention will be described in detail with reference to the accompanying drawing and examples.

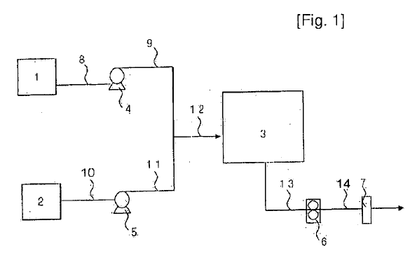

FIG. 1 is a schematic diagram of the polymerization apparatus used for performing polymerization in accordance with the present invention.

A monomer solution stored in a monomer solution reservoir 1, which is kept at up to 25 C, is discharged through a pipe 8. After passing through a pipe 9 via a metric pump 4, the monomer solution is mixed with an initiator solution prior to being supplied to a complete-mixing type continuous reactor 3, as will be described below. An initiator solution is stored in an initiator solution reservoir 2, which is kept at up to 25° C. It is discharged through a pipe 10, passes through a pipe 11 via a metric pump 5, and is mixed with the monomer solution at a pipe 12 prior to being supplied to a complete-mixing type continuous reactor 3. The complete-mixing type continuous reactor 3 is equipped with a jacket which maintains the reaction temperature at 70 to 150° C. While maintaining the liquid level of the complete-mixing type continuous reactor 3 constant, an acrylic ester polymer syrup which has been polymerized to a degree of polymerization of 20 to 70% is discharged through a pipe 13 and is passed through a pipe 14 via a gear pump 6. Then, it passes through a filtering system 7 to obtain the final acrylic ester polymer syrup. The pipes 13, 14 may be heated or cooled, depending on the desired viscosity of the acrylic ester polymer syrup.

Practical and preferred embodiments of the present invention are illustrated as shown in the following examples. However, it will be appreciated that those skilled in the art may, in consideration of this disclosure, make modifications and improvements within the spirit and scope of the present invention.

### EXAMPLES

### Example 1

6 kg of a monomer solution was prepared in the monomer solution reservoir 1 by mixing 96 wt % of 2-ethylhexyl acrylate and 4 wt % of acrylic acid, as a monomer, with 0.08 wt % of pentaerythritol tetrakis(3-mercapto)propionate, as a molecular weight controller. Similarly, 2 kg of an initiator solution was prepared in the initiator solution reservoir 2 by mixing 96 wt % of 2-ethylhexyl acrylate and 4 wt % of acrylic acid, as a monomer, with 0.08 wt % of pentaerythritol tetrakis(3-mercapto)propionate as a molecular weight controller, and 0.0004 wt % of 2,2′-azobis(isobutyronitrile) (AIBN), as an initiator.

Each of the monomer solution in the monomer solution reservoir 1 and the initiator solution in the initiator solution reservoir 2 was bubbled with nitrogen at 700 mL/min for 30 minutes, respectively, in the monomer solution reservoir 1 and the initiator solution reservoir 2 to maintain the dissolved oxygen in the reservoirs at 0.8 ppm. The temperature of the monomer solution and the initiator solution was kept at up to 20° C.

Subsequently, the monomer solution and the initiator solution were discharged, respectively, through pipes 8, 10 and passed through the pipes 9, 11 via the metric pumps 4, 5. The solutions were completely mixed at the pipe 12 and continuous polymerization was initiated by supplying the solution mixture to the complete-mixing type continuous reactor 3.

While maintaining constantly the liquid level of the complete-mixing type continuous reactor 3, which was equipped with the jacket that maintains the reaction temperature at 133° C., an acryl polymer syrup, which had been polymerized to a degree of polymerization of 60%, was discharged through the pipe 13, passed through the pipe 14 via the gear pump 6 and passed through the filtering system 7, to obtain the final acrylic ester polymer syrup.

During the continuous reaction, the monomer solution was supplied at an average rate of 10.9 g/min and the initiator solution was supplied at 1.6 g/min. The jacket temperature was maintained within ±5° C. of the reaction temperature. Sampling was performed at given intervals and the mean residence time was maintained at 2 hours.

### Example 2

An acrylic ester polymer syrup was prepared in the same manner as in Example 1, except that 0.00025 wt % of AIBN was used as the initiator, the polymerization temperature was maintained at 100° C., the monomer solution and the initiator solution were supplied at an average rate of 8.7 g/min and 2.1 g/min, respectively, and the mean residence time was maintained at 2.3 hours.

### Example 3

An acrylic ester polymer syrup was prepared in the same manner as in Example 1, except that 0.00025 wt % of 1,1-di(t-butylperoxy) 3,3,5-trimethylcyclohexane was used as the initiator, the polymerization temperature was maintained at 125° C., the monomer solution and the initiator solution were supplied at an average rate of 8 g/min and 2 g/min, respectively, and the mean residence time was maintained at 2.5 hours.

### Example 4

An acrylic ester polymer syrup was prepared in the same manner as in Example 1, except that 0.00019 wt % of V-65 was used as the initiator, the polymerization temperature was maintained at 90° C., the monomer solution and the initiator solution were supplied at an average rate of 11 g/min and 2 g/min, respectively, and the mean residence time was maintained at 1.9 hours.

### Example 5

An acrylic ester polymer syrup was prepared in the same manner as in Example 1, except that 0.00094 wt % of BPO was used as the initiator, the polymerization temperature was maintained at 110° C., the monomer solution and the initiator solution were supplied at an average rate of 8.3 g/min and 1.9 g/min, respectively, and the mean residence time was maintained at 2.5 hours.

Weight-average molecular weight (M_{w}), degree of polymerization, molecular weight distribution, and degree of continuous polymerization of the resultant acrylic ester polymer syrup were measured. The result is given in Table 1 below.

Samples were taken from the acrylic ester polymer syrups prepared in Examples 1 to 5, and weight-average molecular weight (Mw), degree of polymerization, molecular weight distribution (polydispersity index, PDI) and the degree of continuous polymerization were measured.

TABLE 1

| | Condition of | | | | Batch | | | |
|---|---|---|---|---|---|---|---|---|
| | continuous polymerization | | | | polymerization | Continuous polymerization | | |
| | | Initiator | | | Degree of | Degree of | | |
| | | conc. | Tr | Residence | polymerization | polymerization | Weight-average | |
| | Initiator | (%) | (° C.) | time (hr) | (%) | (%) | molecular weight | PDI |
| Ex. 1 | AIBN | 0.00050 | 133 | 2.0 | 51 | 60 | 285,900 | 4.84 |
| Ex. 2 | AIBN | 0.00025 | 100 | 2.3 | 44 | 47 | 381,700 | 2.73 |
| Ex. 3 | T29 | 0.00025 | 125 | 2.5 | 51 | 49 | 254,500 | 3.22 |
| Ex. 4 | V65 | 0.00019 | 90 | 1.9 | 29 | 32 | 270,600 | 1.98 |
| Ex. 5 | BPO | 0.00094 | 110 | 2.5 | 25 | 35 | 310,500 | 2.46 |

(Note)
PDI - molecular weight distribution
Tr (° C.): temperature inside reactor
AIBN: 2,2′-azobis(isobutyronitrile)
T29: 1,1-di(t-butylperoxy)-3,3,5-trimethylcyclohexane
V65: 2,2′-azobis(2,4-dimethylvaleronitrile)
BPO; dibenzoyl peroxide

As seen in Table 1, the acrylic ester polymer syrups prepared in Examples 1 to 5 were obtained stably without gelation, viscosity increase or poor stirring.

### INDUSTRIAL APPLICABILITY

In accordance with the present invention, an acrylic ester polymer syrup can be obtained with a degree of polymerization of 20 to 70% at a low polymerization temperature, even with a small amount of initiator. Productivity can be improved by reducing the reaction time with the use of an initiator having a short half-life and polymerization can be performed very stably and continuously without gelation.

Those skilled in the art will appreciate that the concepts and specific embodiments disclosed in the foregoing description may be readily utilized as a basis for modifying or designing other embodiments for carrying out the purposes of the present invention. Those skilled in the art will also appreciate that such equivalent embodiments do not depart from the spirit and scope of the present invention as set forth in the appended claims.

1. A method for preparing an acrylic ester polymer syrup using a polymerization apparatus comprising a complete-mixing type continuous reactor, a monomer solution reservoir, and an initiator solution reservoir, which comprises the steps of:
a) supplying a monomer solution and an initiator solution to the monomer solution reservoir and the initiator solution reservoir, respectively;
b) supplying the monomer solution and the initiator solution to the complete-mixing type continuous reactor, while maintaining the dissolved oxygen in the monomer solution reservoir and the initiator solution reservoir at 0.0001 to 3 ppm, separately or after mixing prior to the supply; and
c) performing bulk polymerization continuously while maintaining the solution mixture supplied to the continuous reactor at 70 to 150° C. and 1 to 10 atm, with a mean residence time of 30 to 240 minutes.

2. The method for preparing an acrylic ester polymer syrup as set forth in claim 1, wherein the monomer solution comprises i) an acrylic ester monomer and ii) a molecular weight controller, and the initiator solution comprises i) an acrylic ester monomer, ii) a molecular weight controller and iii) an initiator having a ten hour half life temperature of 40 to 135° C.

3. The method for preparing an acrylic ester polymer syrup as set forth in claim 2, wherein the acrylic ester monomer of i) is at least one acrylic ester monomer having a C₁-C₁₂ alkyl group selected from the group consisting of methyl(meth)acrylate, ethyl(meth)acrylate, propyl(meth)acrylate, butyl(meth)acrylate, hexyl(meth)acrylate, isooctyl(meth)acrylate, 2-ethylhexyl(meth)acrylate and isononyl(meth)acrylate.

4. The method for preparing an acrylic ester polymer syrup as set forth in claim 2, wherein the acrylic ester monomer of i) is mixed with a polar acrylic monomer copolymerizable with the acrylic ester monomer.

5. The method for preparing an acrylic ester polymer syrup as set forth in claim 4, wherein the polar acrylic monomer is at least one polar acrylic monomer selected from the group consisting of: a carboxyl-containing monomer such as (meth)acrylate, maleate and fumarate; a hydroxy-containing monomer such as hydroxy(meth)acrylate and hydroxy(meth)methylacrylate; and a nitrogen-containing monomer such as acrylimicle, N-vinylpyrrolidone and N-vinylcaprolactam, and the amount used is 1 to 20 parts by weight per 100 parts by weight of the acrylic ester monomer.

6. The method for preparing an acrylic ester polymer syrup as set forth in claim 2, wherein an unsaturated monomer such as styrene and benzoyl(meth)acrylate is further added to the acrylic ester monomer of i).

7. The method for preparing an acrylic ester polymer syrup as set forth in claim 2, wherein the molecular weight controller of ii) is at least one mercaptan-based chain transfer agent having a thiol (—SH) group.

8. The method for preparing an acrylic ester polymer syrup as set forth in claim 2, wherein the amount of molecular weight controller of ii) is 0.0001 to 5 wt % per 100 wt % of the total monomers.

9. The method for preparing an acrylic ester polymer syrup as set forth in claim 2, wherein the initiator of iii) is at least one azo-based or peroxide-based initiator having a ten hour half-life temperature of 40 to 135° C.

10. The method for preparing an acrylic ester polymer syrup as set forth in claim 2, wherein the amount of initiator of iii) is 0.00001 to 1 wt % per 100 wt % of the total monomers.

11. The method for preparing an acrylic ester polymer syrup as set forth in claim 1, wherein the acrylic ester polymer syrup has a final degree of polymerization of 20 to 70%.

12. An adhesive comprising an acrylic ester polymer syrup prepared by the method as set forth in claim 1.
